(19) United States
(12) Patent Application Publication
(10) Pub. No.: US 2006/0123398 A1
(43) Pub. Date: Jun. 8, 2006

(54) Apparatus and method for optimization of virtual machine operation

(76) Inventor: James B. McGuire, Delray Beach, FL (US)

Correspondence Address: MOTOROLA INC, 600 NORTH US HIGHWAY 45, ROOM AS437, LIBERTYVILLE, IL, 60048-5343, US

(21) Appl. No.: 11/007,475

(22) Filed: Dec. 8, 2004

(51) Int. Cl. G06F 9/44

(52) U.S. Cl. 717/127

(57) ABSTRACT

An apparatus and method of optimization of virtual machine operation. A source code is divided into source code regions, each source code region comprising a method or a program loop. A current context is compared to the at least one historical context based on at least one of past events and past inputs. The past inputs and past events are prior to current execution of the source code. A source code region is selected as a hot execution spot based on the historical context if the current context is substantially similar to the historical context.

### BACKGROUND

1. Field

The present disclosure is directed to a method and apparatus for optimization of virtual machine operation. More particularly, the present disclosure is directed to optimizing virtual machine hot spot operation.

2. Description of Related Art

Presently, Virtual Machines, such as Java, are composed of a compiler and a byte-code interpreter. The compiler converts the human readable source code to bytes-codes. These byte-codes are machine-independent. The byte-codes are then executed by a native application. This native application often referred to as a byte-code interpreter.

Currently, Java optimizations take advantage of the fact that virtually all programs spend the vast majority of their time executing a small minority of their code. This small minority of code is called a hot spot. The hot spots are compiled by a Just-In-Time (JIT) compiler. A JIT compiler runs on an end-user's device executing the byte codes and compiling each method. If compiled byte codes are no longer the hot-spot, the code compiled by the JIT can be unloaded to make room for the new hot spot.

The hot-spot of a Virtual Machine interpreter is determined by profiling the execution of the code. It counts the number of times a method or class is called. If a certain threshold is reached, the method or class is run through the JIT compiler as a hot-spot.

The disadvantage of this approach is that as the device is used for different tasks, the hot spot shifts. As the host spot shifts, unfortunately there is a delay before the profiling detects that the shift occurred. Then, after the delay, and as the user continues the same task, the performance of the Virtual Machine can improve.

Thus, there is a need for an improved apparatus and method of optimization of virtual machine operation. For example, there is a need to improve performance of a Virtual Machine without unnecessary delays.

### SUMMARY

The disclosure provides an improved apparatus and method of optimization of virtual machine operation. A source code is divided into source code regions, each source code region comprising a method or a program loop. A current context is compared to the at least one historical context based on at least one of past events and past inputs. The past inputs and events are prior to current execution of the source code. A source code region is selected as a hot execution spot based on the historical context if the current context is substantially similar to the historical context.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a device according to one embodiment;

FIG. 2 is an exemplary flowchart illustrating the operation of the device according to another embodiment; and

FIG. 3 is an exemplary flowchart illustrating the operation of the device according to one embodiment.

### DETAILED DESCRIPTION

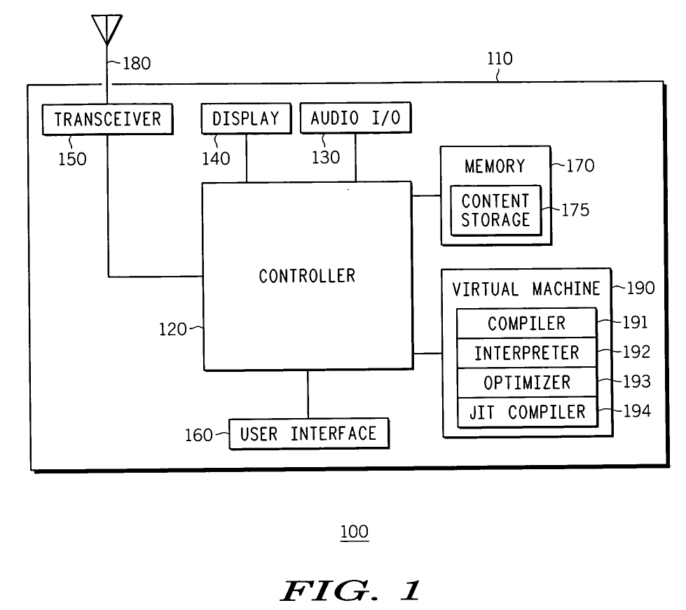

FIG. 1 is an exemplary block diagram of a device 100, according to one embodiment. The device 100 can include a housing 110, a controller 120 coupled to the housing 110, audio input and output circuitry 130 coupled to the controller 120, a display 140 coupled to the controller 120, a transceiver 150 coupled to the controller 120, a user interface 160 coupled to the controller 120, a memory 170 coupled to the controller 120, and an antenna 180 coupled to the housing 110 and the transceiver 150. The memory 170 can include a historical context storage 175. The device 100 can also include a virtual machine 190 having a compiler 191, an interpreter 192, an optimizer 193, and a just-in-time compiler 194. The virtual machine 190 can be coupled to the controller 120, can reside within the controller 120, can reside within the memory 170, can include autonomous modules, can be software, can be hardware, or can be in any other format useful for a module on a device 100.

The display 140 can be a liquid crystal display (LCD), a light emitting diode (LED) display, a plasma display, or any other means for displaying information. The transceiver 150 may include a transmitter and/or a receiver. The audio input and output circuitry 130 can include a microphone, a speaker, a transducer, or any other audio input and output circuitry. The user interface 160 can include a keypad, buttons, a touch pad, a joystick, an additional display, or any other device useful for providing an interface between a user and an electronic device. The memory 170 may include a random access memory, a read only memory, an optical memory, a subscriber identity module memory, or any other memory that can be coupled to a device.

The device 100 may be a telephone, a wireless telephone, a cellular telephone, a personal digital assistant, a pager, a personal computer, a mobile communication device, a selective call receiver or any other device that is capable of implementing a virtual machine. The device 100 may send and receive signals on a network. Such a network can include any type of network that is capable of sending and receiving signals, such as wireless signals. For example, the network may include a wireless telecommunications network, a cellular telephone network, a satellite communications network, and other like communications systems. Furthermore, the network may include more than one network and may include a plurality of different types of networks. Thus, the network may include a plurality of data networks, a plurality of telecommunications networks, a combination of data and telecommunications networks and other like communication systems capable of sending and receiving communication signals.

In operation, the historical context storage 175 can include at least one historical context based on past events and/or past inputs. The virtual machine optimizer 193 can divide a source code into source code regions, each source code region having a method or a program loop. The virtual machine optimizer 193 can compare a current context to the at least one historical context based on at least one of past events and past inputs. The past events and past inputs can be prior to current execution of the source code. The virtual machine optimizer 193 can select a source code region as a hot execution spot based on the historical context if the current context is substantially similar to the historical context. For example, the hot execution spot can be a source code region executed more often than other source code regions. A context can be a time of day, a location of the device, a user of the device, connections to the device, a selected application on the device, accessories used on the device, or any other contexts.

The virtual machine compiler 191 can be configured to convert source code into byte codes and the virtual machine interpreter 192 can execute the byte codes. The just-in-time compiler 194 can compile the hot execution spot from source code into object code. The hot execution spot can be a source code region executed more often than other source code regions. The historical context storage 175 can store information corresponding to the at least one historical context. The information can include optimization of a source code region, the number of times a source code region is called, and/or the percentage of time spent on a source code region. The information can also include past events and/or past inputs during a previous execution of the source code.

The virtual machine optimizer 193 can also collect information corresponding to the current context. The collected information can include optimization of a source code region, the number of times a source code region is called, and/or the percentage of time spent on a source code region. The virtual machine optimizer 193 can store the information corresponding to the current context as information corresponding to a historical context. The virtual machine optimizer 193 can also determine a new task is being executed and re-compare a current context to the at least one historical context when a new task is being executed. For example, a new task may be a different application or a different source code.

Thus, a byte code interpreter 192 or a virtual machine 190 can be optimized based on external inputs and historical contexts. The interpreter 192 or virtual machine 190 is not only optimized based on current operation but is also optimized based on use context history. For example, if a similar historical context as the current context is found, the historical context's optimizations can be loaded. The current and historical context can be determined by events and inputs external to the virtual machine 190.

When loading a historical context, the optimizer 193 can attempt match the current context with a historical context based on a time interval and/or based on an external event or input. If it can find a match, the optimizations that were done for the historical context are loaded. When saving a historical context, at the beginning of a time interval or on an external event, the optimizer 193 can begin to store information on which classes are optimized, how often the classes are called, and/or the percentage of time spent in each class. The information can be stored and can be retrieved on the next occurrence of a similar time interval or the next time a match of the external event occurs. The information can then be used to optimize the current context. Therefore, for example, the optimizer 193 can anticipate the optimization of byte codes. Accordingly, when the user performs a task, the byte-codes for the task are already optimized.

As an example, a commuter can play the same game on his/her train ride home. The optimizer 193 can notice the same classes are optimized at the same time every day and can optimize the classes before the user begins to play. As another example, if a user stops at the same gas station and pays with his/her cell phone account, the optimizer 193 can detect that the user is at the gas station and can load optimized eCommerce classes before the transaction tacks place. As a further example, children in a house can share a cell phone and each child may log on before they use the phone. The optimizer 193 can be notified of the log in and can know the profile of use by each child. The appropriate optimized classes can be loaded when a specific child logs on. For example, one child may use the phone for Instant Messaging while the other may use the phone for games. The optimizer 193 can also know when a phone is connected to a personal computer and that the user almost always synchronizes the phone with Outlook. The optimizations that help synchronization can be loaded as soon as a connection cable is plugged in. The optimizer 193 can further know the when a car kit is attached, the most common mode of operation is hands free, and appropriate optimized classes can be loaded. When an application is exited, the virtual machine 190 can mark the classes that are currently considered the hot-spot. The next time the application runs, these optimized classes can be loaded.

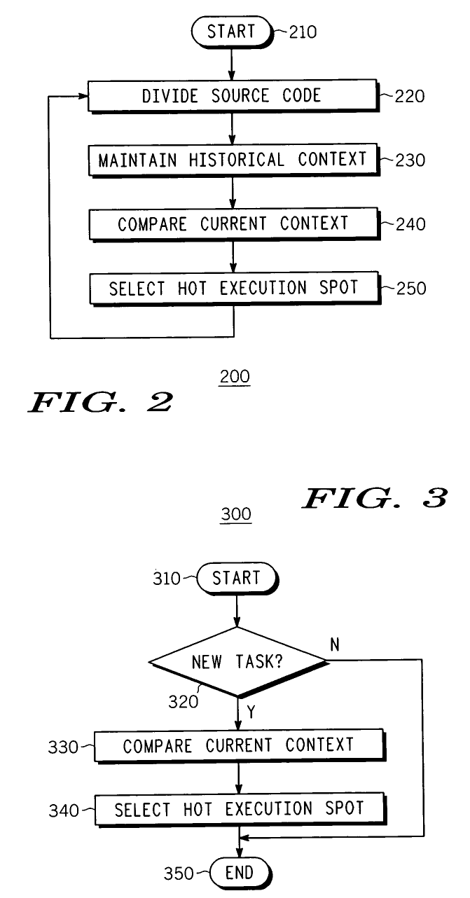

FIG. 2 is an exemplary flowchart 200 illustrating the operation of the device 100 according to another embodiment. In step 210, the flowchart begins. In step 220, the device 100 can divide a source code into source code regions. Each source code region can be a method or a program loop. In step 230, the device 100 can maintain at least one historical context based on past events, past inputs and/or other information. When maintaining a historical context, the device 100 can store information corresponding to at least one historical context. The information can include optimization of a source code region, the number of times a source code region is called, the percentage of time spent on a source code region, and/or the like. The information can also include past events, past inputs, or the like during a previous execution of the source code. When maintaining a historical context, the device 100 can also collect information corresponding to the current context. The collected information can include optimization of a source code region, the number of times a source code region is called, the percentage of time spent on a source code region, and/or the like. The device 100 can then store the information corresponding to the current context as information corresponding to a historical context.

In step 240, the device 100 can compare a current context to the at least one historical context based on the past events and past inputs. The past events and past inputs being prior to current execution of the source code. In step 250, the device 100 can select a source code region as a hot execution spot based on the historical context if the current context is substantially similar to the historical context. The hot execution spot can be a source code region compiled into an object code by the just-in-time compiler 194.

FIG. 3 is an exemplary flowchart 300 illustrating the operation of the device 100 according to another related embodiment. The steps in the flowchart 300 can be combined with the steps in the flowchart 200. In step 310, the flowchart begins. In step 320, the device 100 can determine whether a new task is being executed. If a new task is being executed, in step 330 the device 100 can re-compare a current context to the at least one historical context when a new task is being executed. In step 340, the device 100 can then select a hot execution spot based on the comparison of the current context to the historical context. In step 350, the flowchart 300 can end.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A method in a device comprising:
dividing a source code into source code regions, each source code region comprising a method or a program loop;
maintaining at least one historical context based on at least one of past events and past inputs;
comparing a current context to the at least one historical context based on at least one of past events and past inputs prior to current execution of the source code; and
selecting a source code region as a hot execution spot based on the historical context if the current context is substantially similar to the historical context.

2. The method according to claim 1, wherein a hot execution spot comprises a source code region compiled into an object code by a just-in-time compiler.

3. The method according to claim 1, further comprising storing information corresponding to at least one historical context,
wherein the information includes
at least one of optimization of a source code region, the number of times a source code region is called, and the percentage of time spent on a source code region, and
at least one of past events and past inputs during a previous execution of the source code.

4. The method according to claim 1, further comprising:
collecting information corresponding to the current context, the collected information including at least one of optimization of a source code region, the number of times a source code region is called, and the percentage of time spent on a source code region; and
storing the information corresponding to the current context as information corresponding to a historical context.

5. The method according to claim 1, further comprising:
determining a new task is being executed; and
re-comparing a current context to the at least one historical context when a new task is being executed.

6. The method according to claim 1, wherein a historical context comprises a time of day.

7. The method according to claim 1, wherein a historical context comprises a location of the device.

8. The method according to claim 1, wherein a historical context comprises a user of the device.

9. The method according to claim 1, wherein a historical context comprises connections to the device.

10. The method according to claim 1, wherein a historical context comprises a selected application on the device.

11. The method according to claim 1, wherein a historical context comprises accessories used on the device.

12. A device comprising:
a historical context storage including at least one historical context based on at least one of past events and past inputs; and
a controller including a virtual machine, the virtual machine having:
a virtual machine compiler;
a virtual machine interpreter; and
a virtual machine optimizer, the virtual machine optimizer being configured to divide a source code into source code regions, each source code region comprising a method or a program loop, compare a current context to the at least one historical context based on at least one of past events and past inputs prior to current execution of the source code, and select a source code region as a hot execution spot based on the historical context if the current context is substantially similar to the historical context.

13. The device according to claim 12, wherein the virtual machine compiler is configured to convert source code into byte codes, and
wherein the virtual machine interpreter is configured to execute the byte codes.

14. The device according to claim 12, further comprising a just-in-time compiler configured to compile the hot execution spot from source code into object code.

15. The device according to claim 12, wherein a hot execution spot comprises a source code region executed more often than other source code regions.

16. The device according to claim 12, wherein the historical context storage further stores information corresponding to the at least one historical context,
wherein the information includes
at least one of optimization of a source code region, the number of times a source code region is called, and the percentage of time spent on a source code region, and
at least one of past events and past inputs during a previous execution of the source code.

17. The device according to claim 12, wherein the virtual machine optimizer is further configured to collect information corresponding to the current context, the collected information including at least one of optimization of a source code region, the number of times a source code region is called, and the percentage of time spent on a source code region and store the information corresponding to the current context as information corresponding to a historical context.

18. The device according to claim 12, wherein the virtual machine optimizer is further configured to determine a new task is being executed and re-compare a current context to the at least one historical context when a new task is being executed.

19. The device according to claim 12, wherein a historical context comprises at least one of a time of day, a location of the device, a user of the device, connections to the device, a selected application on the device, and accessories used on the device.

20. A selective call receiver comprising:
a transceiver;
a memory having a historical context storage, the historical context storage including at least one historical context based on at least one of past events and past inputs; and
a controller coupled to the transceiver and the memory, the controller including a virtual machine, the virtual machine having:
a virtual machine compiler;
a virtual machine interpreter; and
a virtual machine optimizer, the virtual machine optimizer being configured to divide a source code into source code regions, each source code region comprising a method or a program loop, compare a current context to the at least one historical context based on at least one of past events and past inputs prior to current execution of the source code, and select a source code region as a hot execution spot based on the historical context if the current context is substantially similar to the historical context.
